(19) United States
(12) Patent Application Publication
(10) Pub. No.: US 2009/0271252 A1
(43) Pub. Date: Oct. 29, 2009

(54) Method for developing and implementing an employee incentive plan

(76) Inventor: Bruce AmEnde, Manchester, CT (US)

Correspondence Address: Robert L. Rispoli;Clayman , Tapper & Baram , LLC., 3 Regency Drive, Bloomfield, CT, 06002, US

(21) Appl. No.: 12/386,448

(22) Filed: Apr. 17, 2009

Related U.S. Application Data
(60) Provisional application No. 61/124,616, filed on Apr. 18, 2008.

(51) Int. Cl. G06Q 10/00; G06Q 40/00

(52) U.S. Cl. 705/11; 705/35

(57) ABSTRACT

The employee incentive plan provides a method and system for tracking, calculating and implementing a self-adjusting employee incentive plan. The present invention provides a method and system for establishing an incentive plan, aligning the incentive plan to the employer's management and human resources goals, determining key attributes and related ranges, defining success factors, assessing incentive program reward constraints, and recommending a suitable employee incentive plan based upon all of the generated factors and inputs.

### CROSS-REFERENCE TO RELATED APPLICATION

This application claims the benefit of U.S. Provisional Application No. 61/124,616 filed Apr. 18, 2008.

### FIELD OF THE INVENTION

In economics and sociology, an incentive is any factor, financial or non-financial, that enables or motivates a particular course of action, or counts as a reason for preferring one choice in comparison to the alternatives. It is an expectation that encourages people to behave in a certain way. One type of incentive is performance-related pay wherein money is paid to someone related to how well he or she works on a job-related activity. The present invention provides a method and system for tracking, calculating and implementing an employee incentive program. In particular, the present invention provides a self-adjusting employee incentive plan. More particularly, the present invention provides a method and system for establishing an incentive plan, aligning the incentive plan to the employer's management and human resources goals, determining key attributes and related ranges, defining success factors, assessing incentive program reward constraints, and recommending a suitable employee incentive plan based upon all of the generated factors and inputs.

### BACKGROUND OF THE INVENTION

Merit pay is a term describing performance-related pay. It provides monetary bonuses for workers who perform their jobs better according to specified measurable criteria. Incentive programs or plans are particularly used by business management to motivate employees, and in sales in order to attract and retain customers. If programs are to be effective, all the factors that affect behavior must be recognized, including: motivation, skills, recognition, an understanding of goals, and the ability to measure progress.

An incentive program or plan represents a substantial investment to most organizations. Receiving a sufficient return on that investment requires the full participation of the program participants. Incentive programs or plans are based upon the concept that effort increases as people perceive themselves progressing toward their specific goal. Therefore, programs should offer participants a variety of products and services based on their unique interests and diverse needs.

Successful programs and plans must comprise carefully developed reward methods to keep participants eager to approach a new goal once the participants have achieved a reward. Objectives should be based upon the basis of the organization's strategic goals and should be straightforward and specific so that participants clearly understand the expectations. Objectives may include motivating employees, recognizing performance, persuading customers to make a purchase, or even reinforcing a marketing message.

Once the program or plan goals have been determined, every aspect of the program or plan must be measured against this goal in order to ensure the program's success in goal achievement. If successful, objectives should provide measurable results allowing the organization to track performance and measure the overall success of the program.

In U.S. Patent Publication US2005/0209917 to Anderson, an employee incentive program is disclosed. According to the description, an employee account is credited with a first amount when a new customer account is opened. The employee account is also credited when an existing customer account is used. In a further description of this invention, the employee account is credited with a third amount when an account opened by the employee is used.

Another prior art example, U.S. Patent Publication US2002/0035506 to Loya, discloses a system for creating incentive plans to motivate and reward employees comprising a series of computer programs or tools which customize, develop, and implement an incentive plan for a variety of businesses. A first tool is disclosed and comprises a computer program that features an employee survey program. The program allows users to customize an employee survey, automate the analysis of the survey, and generate graphic illustrations of the survey results. A second tool is disclosed and comprises a computer program that enable users to facilitate important functions integral to the design and implementation of an incentive plan, such as setting up an incentive program, entering program data, automating periodic benefit calculations, and generating employee benefit statements, employee periodic reviews, and periodic management reports. The program also provides sample documents of an actual corporate incentive program and of an individual incentive program that a user can modify according to specific needs of a corporation or an individual for virtual immediate implementation and use of a customized incentive plan.

U.S. Pat. No. 7,054,830 to Eggleston discloses a method and system for providing incentive programs over a computer network in which a host may provide sponsoring companies with the capability to buy prepackaged or self-built incentive programs, offer such incentive programs to consumers, provide sponsoring companies and retailers with the capability to associate prizes with incentive programs, provide sponsoring companies, retailers and consumers with convenient fulfillment of prizes, and store and manipulate databases regarding all of the foregoing.

In U.S. Patent Publication US 2003/0200142 to Hicks, a method and system is disclosed for administering and redeeming accumulated employee loyalty points over a distributed computer network such as a company's Intranet or the Internet. In general, the method includes two web-based modules which deliver the program to the employer/employee with interconnectivity to external systems. An employer administrative module allows managers to easily award points as well as run reports to track incentive activity. The employee module allows employees to check and redeem their points online. Employees can earn points for particular behaviors including perfect attendance, meeting sales quotas, or meeting a project deadline. The employee module offers secured login and handles point redemptions for items including certificates, merchandise, and travel. In addition to these modules, interconnectivity to various human resources information systems, payroll, and compensation systems is provided.

Problems associated with the prior art include a lack of functional programmability whereby the incentive program can be easily adapted to accommodate a variety of employers, industries and management styles. In addition, none of the prior art systems permit the employer to calculate an available bonus pool prior to awarding the incentive bonus.

It is one object of the present invention to provide a method and a system of tracking, calculating and implementing an employee incentive program. It is another object of the present invention to provide a method and system for establishing an incentive plan, aligning the incentive plan to the employer's management and human resources goals, determining key attributes and related ranges, defining success factors, assessing incentive program reward constraints, and recommending a suitable employee incentive based upon all of the generated factors and inputs. It is yet another object of the present invention to provide a method and system for generating an incentive program that can be easily adapted to accommodate a variety of employers, industries and management styles. It is yet another object of the present invention to provide an incentive plan that permits an employer to calculate an available bonus pool prior to awarding the incentive bonus.

### DESCRIPTION OF THE INVENTION

Typically, an incentive plan is a team-oriented, performance-based program applicable to organizations that produce products, manage projects and/or provide services. It is designed to maximize employee engagement and their understanding of key business drivers and performance-related success factors. Employees participating in the incentive plan receive variable compensation in the form of bonuses; providing, however, that the organization, team and their respective individual performance meets or exceeds discreet, objective and well-defined business-related performance standards.

Employee eligibility and level of participation for the incentive plan is based on performance units. For example, performance units may be based on number of units produced, number of sales, hours worked or any one of a number of criteria defined or selected to measure employee performance.

Bonuses are distributed at a defined time, typically coinciding with the annual compensation cycle, and are provided only if the organization meets or exceeds defined financial goals.

### BRIEF DESCRIPTION OF THE DRAWINGS

FIG. 1 is a flow diagram illustrating a preferred embodiment of the present invention and defining a summary of the development and implementation of an employee incentive plan.

FIG. 2 is a flow diagram illustrating the management input process of the embodiment shown in FIG. 1.

FIG. 3 is a flow diagram illustrating the human resource input process of the embodiment shown in FIG. 1.

FIG. 4 is a flow diagram illustrating the value factor input process of the embodiment shown in FIG. 1.

FIG. 5 is a flow diagram illustrating the success factor input process of the embodiment shown in FIG. 1.

FIG. 6 is a flow diagram illustrating the incentive calculation process input of the embodiment shown in FIG. 1.

FIGS. 7 and 8 provide a flow diagram illustrating the tool calculation input processes of the embodiment shown in FIG. 1.

FIG. 9 is an illustration of the manager reports generated by the employee incentive program shown in FIG. 1.

FIG. 10 is an illustration of a sample value factor determination worksheet generated by the employee incentive program shown in FIG. 1.

FIG. 11 is an illustration of a sample success score table worksheet generated by the employee incentive program shown in FIG. 1.

FIG. 12 depicts the legend for the flowchart symbols utilized in FIGS. 1-11.

### DETAILED DESCRIPTION OF THE INVENTION

The present invention comprises a method and system for tracking, calculating and implementing an employee incentive plan. According to the present invention, development and implementation of the employee incentive plan requires a detailed review and consensus on salient decision points with the organization's key management and human resource personnel. In the Figures accompanying this specification, the term “Client” represents an organization that has chosen to develop and implement an Employee Incentive Plan in accordance with the present invention. Thus, within this specification, the term “client” and the term “employer” are synonymous. The Client represents a typical employer that has established the teams referenced in the flowcharts to perform the function specified. In addition, the terms “incentive program”, “incentive plan”, “employee incentive program”, and “employee incentive plan” all refer to the basic embodiment of the present invention.

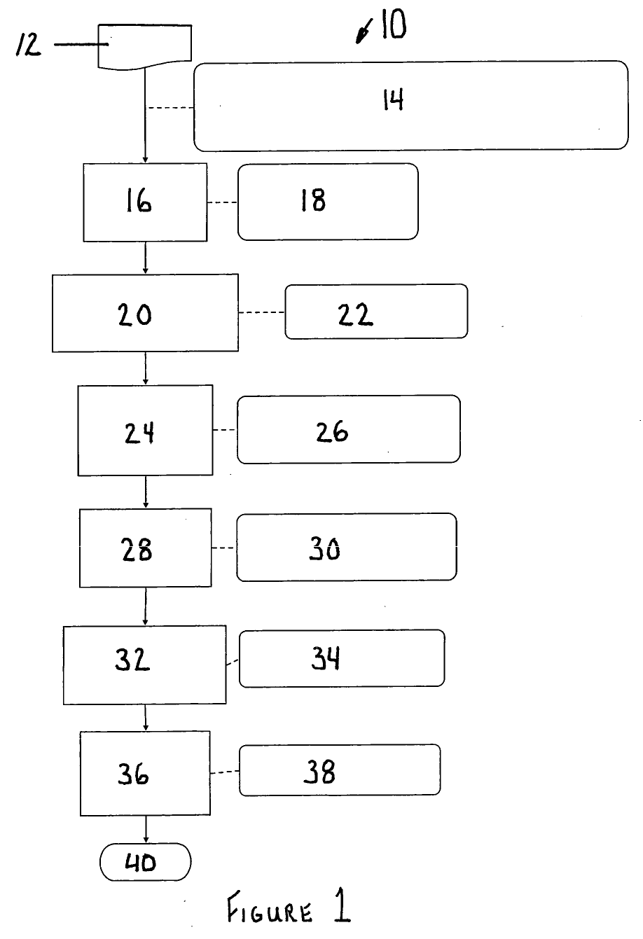

Development of an incentive plan in accordance with the present invention provides a well-defined, objective-based execution path. All of the tasks and steps listed are critical to the successful completion of the incentive plan. As shown in FIGS. 1 through 11, the detailed steps, paths and calculations provide a platform for performing the analysis and for report generation to be used by management and human resources personnel.

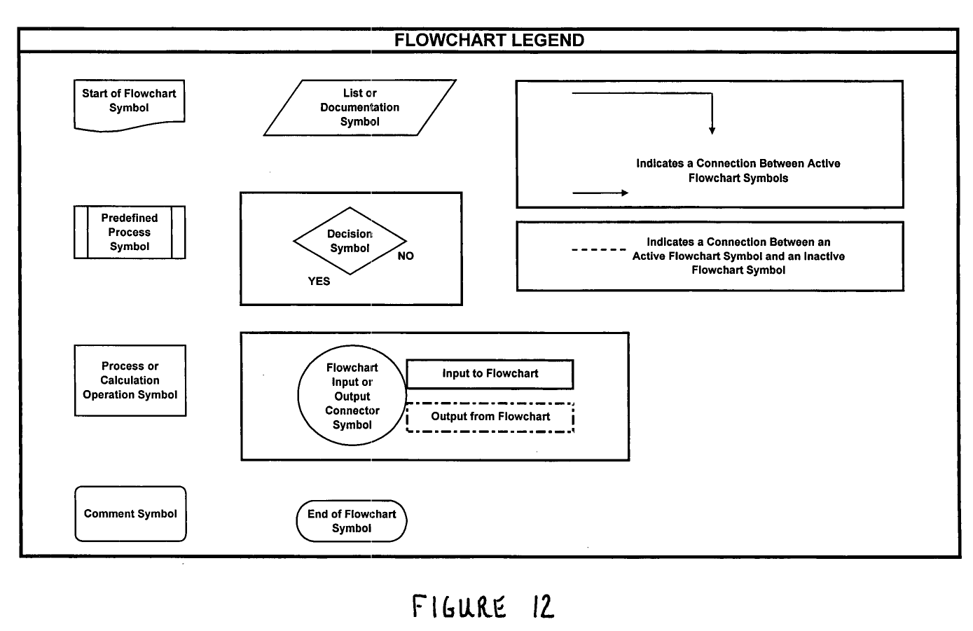

FIG. 12 provides a legend of indicia depicted in FIGS. 1-11 and the respective significance of each symbol used in the flowcharts illustrated in FIGS. 1-11.

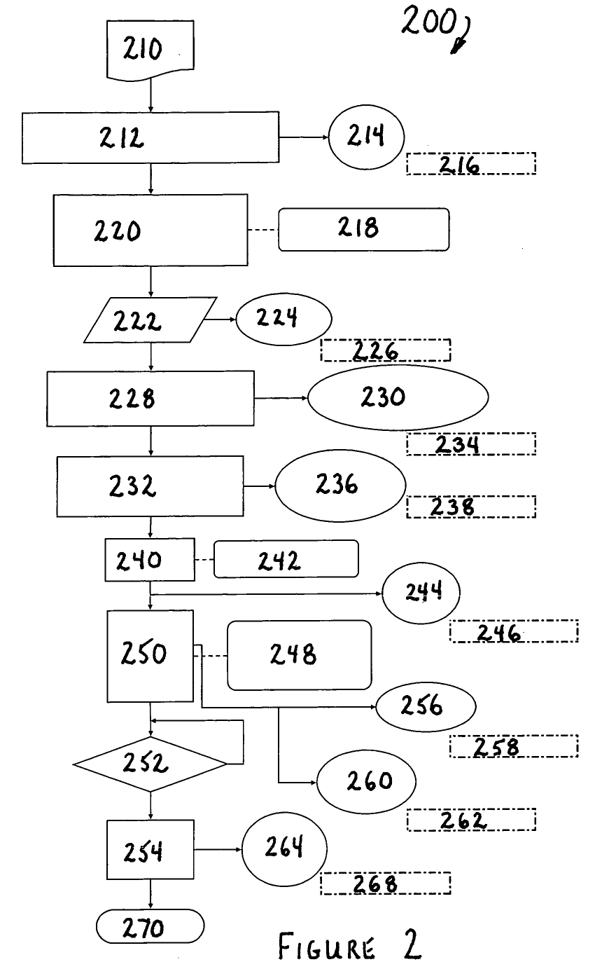

As shown in FIG. 1, a summary flowchart 10 of the development of an incentive plan is illustrated. At the start of the plan 12, each employee eligibility and level of participation for the plan is determined based on several defined or selected performance units as shown in step 14. A review 16 of the incentive plan with the Client Management Team to obtain key decision point agreements is made. As shown in step 18, the Client Management Team follows the process set forth in FIG. 2, the Management Input Flowchart 200, for details pertaining to the Management Review Process. For illustration purposes, all the flowcharts and examples contained within the client incentive plan use hours worked as the measure of employee performance units.

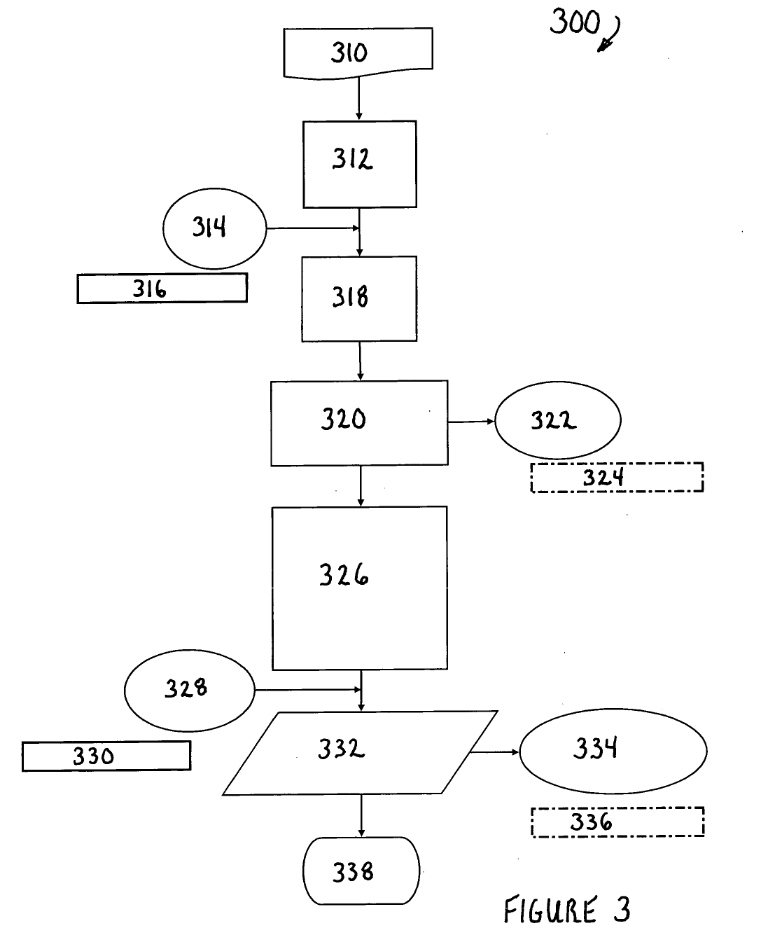

As shown in step 20 and 22, the Client Management Team reviews its key decision point agreements with the Client Human Resources Management Team by following the process set forth in FIG. 3, the Human Resources Flowchart 300.

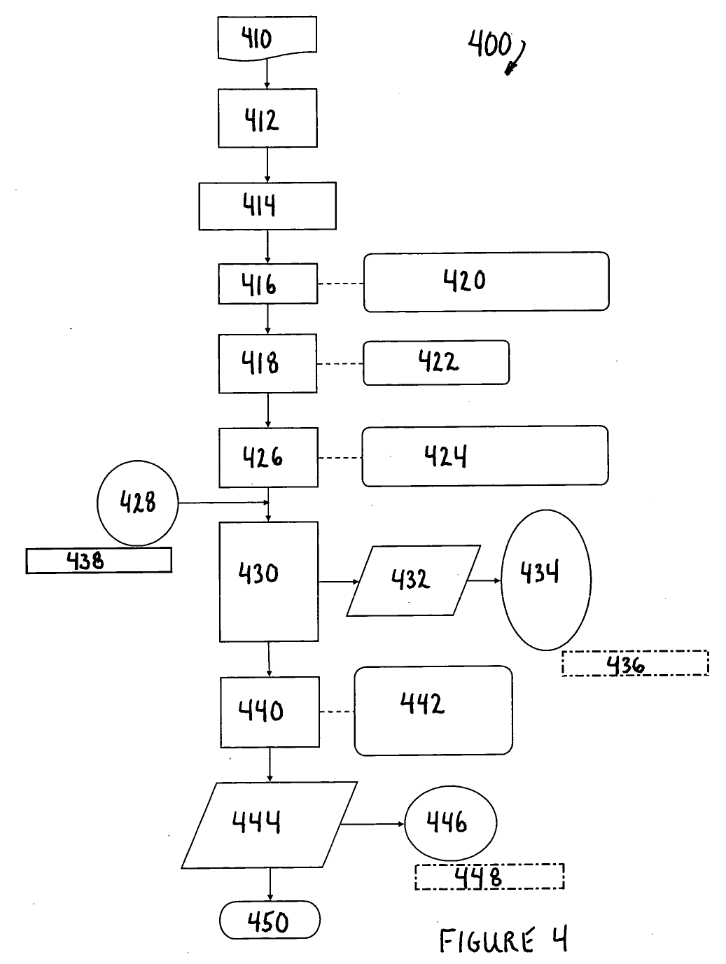

The next step 24 in crafting the incentive plan is to determine key attributes and ranges which will be used to construct the value factor matrix 418 depicted in FIG. 4 for products, projects and/or services that are included in the incentive plan. As shown in step 26, The Value Factor Flowchart 400 provides details pertaining to value factor considerations and calculations which contribute to the determination of the key attributes and ranges.

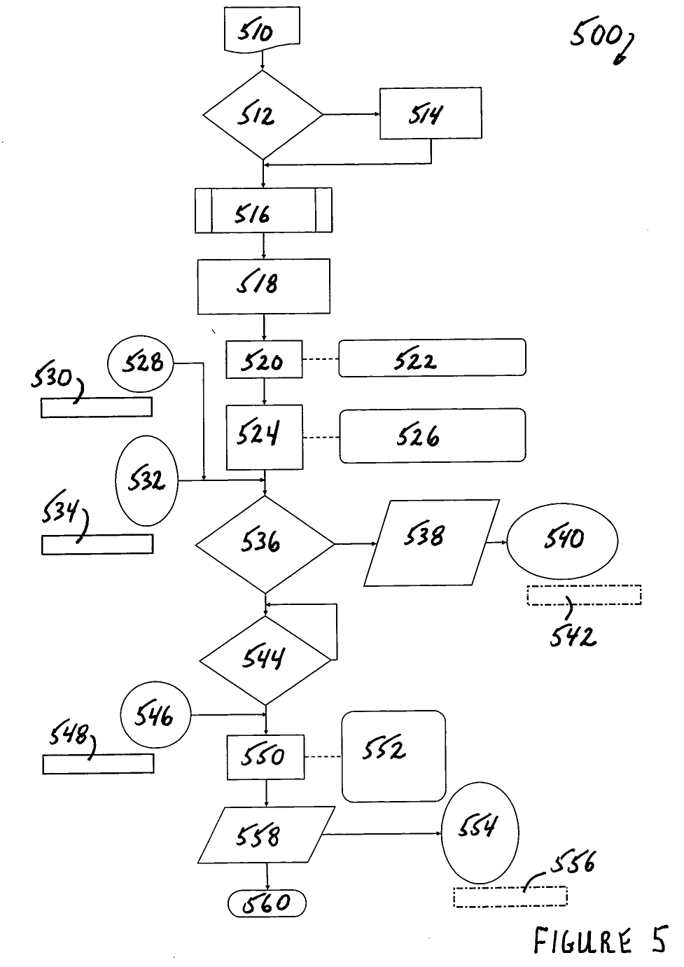

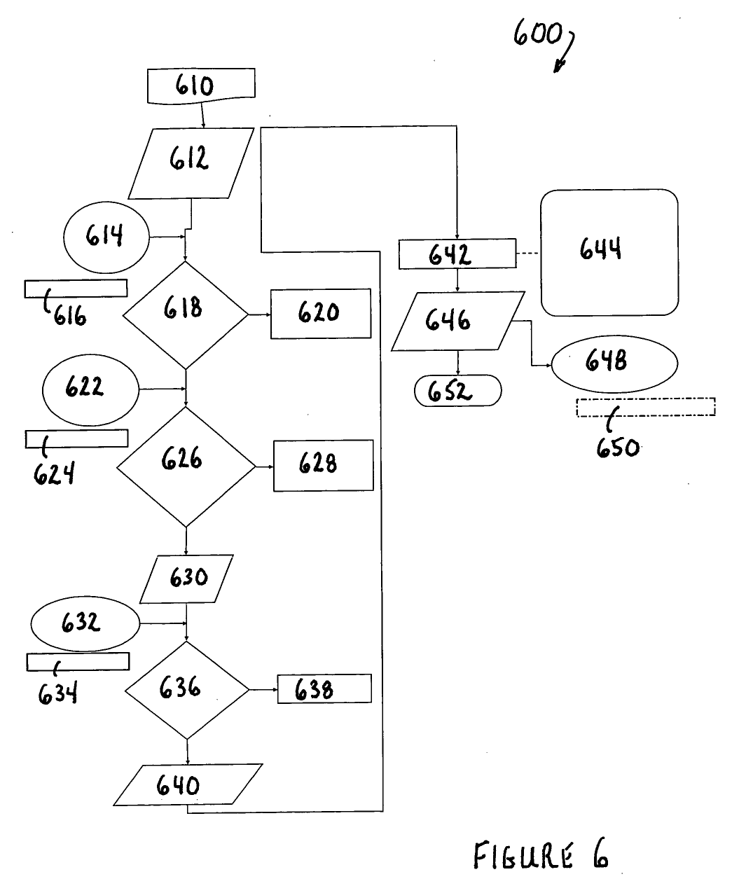

As the development of incentive plan proceeds, a determination of success factors 28 for products, projects and/or services included in the incentive plan must be made. As shown in step 30, the Success Factors Flowchart 500 depicted in FIG. 5 provides details pertaining to success factor considerations and calculations. In step 32, Management and Human Resources perform an employee eligibility and product, project and/or services year-end results calculations and create related pertinent documentation. As shown in step 34, Management and Human Resources follow the process set forth in the Incentive Calculations Flowchart 600 depicted in FIG. 6 for details regarding the incentive plan calculations and related pertinent documentation.

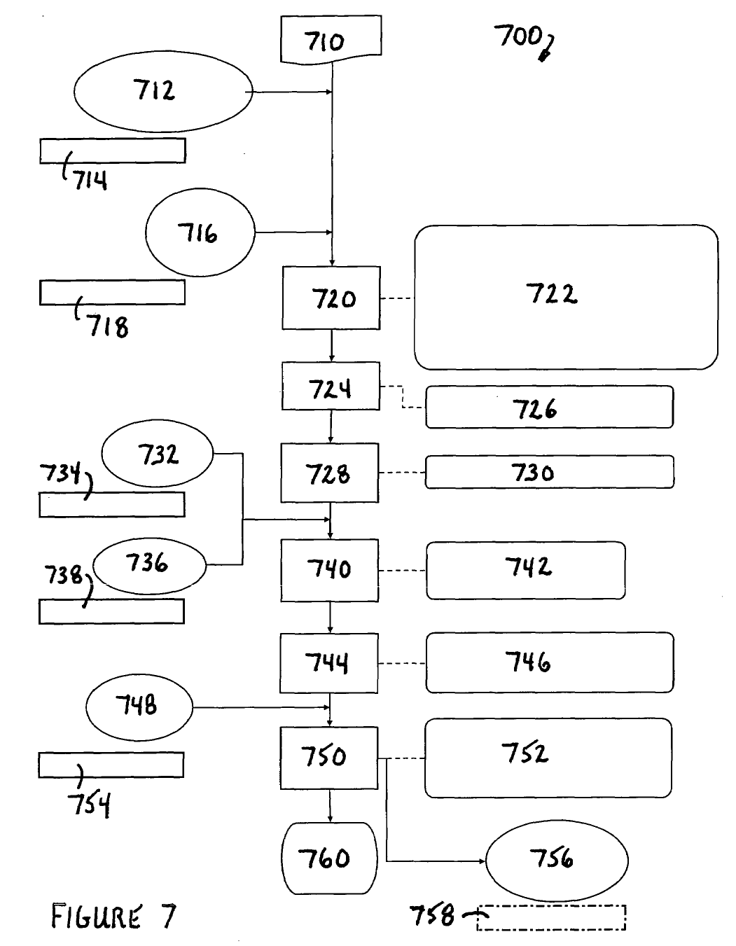

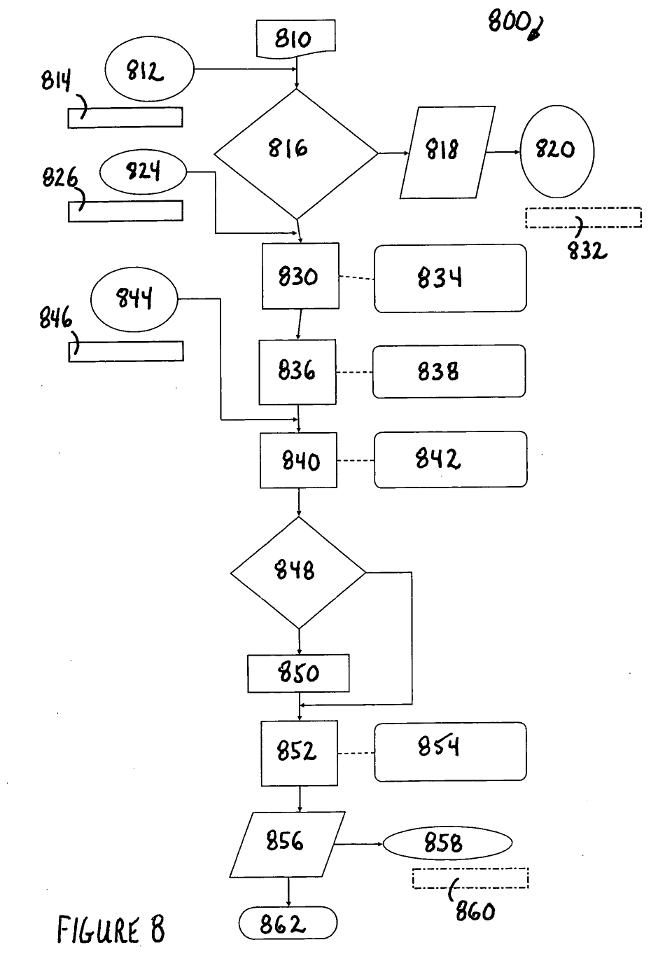

Development of the incentive plan process culminates with the determination of the incentive plan bonus recommendation calculations and creation of related pertinent documentation 36. As shown in step 38, Management and Human Resources utilize the process set forth in the Tool Calculation Flowchart Sheet 1 700 and Sheet 2 800 depicted in FIGS. 7 and 8 for details regarding Bonus Recommendations Calculations and related pertinent documentation. The development and implementation of the employee incentive plan is complete at step 40.

As stated above, the Management Input Process is initiated at step 210 as depicted in FIG. 2, the Management Input Flowchart 200. This process provides the input for the Management Review Process, steps 16 and 18 of the summary depicted in FIG. 1. The first step 212 of the Management Input Process requires the Client Management Team to determine an incentive plan start and end date 214. The end date should coincide with an annual employee evaluation time period. After the incentive plan start and end dates 214 are determined, the information is output 216 to the Value Factor & Success Factor Flowchart 400.

In step 220, the Client Management Team will determine the Maximum Bonus Potential for employees included in the incentive plan. Maximum Bonus Potential is determined by assigning maximum bonus potentials to groupings of possible success scores to be calculated at step 218 as illustrated in FIG. 8. Once they create the Maximum Bonus Potential Table 224 in step 222, the information is output 226 and utilized in the Tool Calculation Flowchart Sheet 2 800 depicted in FIG. 8.

The next step 228 requires that the Client Management Team determine the minimum number of hours an employee must charge to a given product, project and/or service to be included in Employee's Incentive Bonus Calculation. A minimum hour's per product, project and/or service 230 is required for inclusion in the incentive plan bonus calculation and is output 234 to the Incentive Calculation Flowchart 600 depicted in FIG. 6.

The next step 232 requires that the Client Management Team determine the minimum number of total hours an employee must charge to a given product, project and/or service to be included in Employee's Incentive Bonus Calculation. A minimum number of total hours per product, project and/or service 236 is required for inclusion in the incentive plan bonus calculation and is output 238 to the Incentive Calculation Flowchart 600 depicted FIG. 6.

The next step 240 requires the Client Management Team to establish a business results threshold 242 for funding the incentive plan, and subsequently create the Incentive Plan Funding Formula 244. Finally, the information is output 246 and utilized in the Human Resource Flowchart 300 shown in FIG. 3.

Then next step 250 in the Management Input process is to determine the number of manager funding pools, employees in each pool, and the basis for funding the level for each pool. An example 248 comprises the different funding pools: (i) exempt and non-exempt employees; or (ii) managers and individual contributors. Another example of a funding pool comprises the employees that have worked on a selected product, project and/or service. The number of Manager Funding Pools 256 is output 258 and utilized in the calculations shown in Tool Calculation Flowchart Sheet 1 700 depicted in FIG. 7. The List of Employees in Each Funding Pool 260 is output 262 and utilized in the process set forth in the Human Resource Flowchart 300 shown in FIG. 3.

The Client Management Team reaches a decision point 252 and must determine if the incentive plan period should be closed or ended. If the period is ended then the next step 254 comprises the Management Team calculating the Incentive Plan Funding per Pool 264. This information is output 268 and utilized in the Tool Calculation Flowchart Sheet 2 800 depicted in FIG. 8. The end 270 of the Management Input Process is now reached. However, if the decision 252 to end the incentive plan period is no, then the process goes back to the Client Management Team to determine the appropriate close or end of the period.

The next step in developing an incentive plan in accordance with the present invention comprises a Human Resource Input Process 300 depicted in FIG. 3. At the start 310 of the Human Resource Input Process, a review 312 of incentive plan salient features with the Client Human Resource Department is performed. The Incentive Plan Funding Formula 244/314 is input 316 from the Management Input Process. In step 318, a review of the Incentive Plan Funding Formula with the Client Human Resources Department is performed.

In step 320, a determination of the employee percentage of a bonus based on the incentive plan and a percentage of a bonus based on individual performance results is made. The employee percentage of bonus 322 is output 324 and utilized in the Tool Calculation Flowchart Sheet 1 700 of FIG. 7.

The Human Resources Department in step 326 reviews the list and format of the Human Resources Department—supplied incentive plan data (e.g., Employee Name, Manager Name, Employee Identification Number, Department Number, Salary and Bonus Target). The Human Resources Department will establish due dates (e.g., Three Weeks Prior to incentive plan End Date) for Human Resources to supply the required data and also provide Employee Review/Scorecard Ratings.

The List of Employees in Each Funding Pool 260/328 is input 330 from the Management Input Flowchart 200. In step 332, the Human Resources Department will generate the required Human Resources Data Documents for all employees per the Funding Pool. The Human Resources Data Documents for all employees per the Funding Pool 334 is output 336 and utilized in the processes set forth in Tool Calculation Flowchart Sheet 1 700 and Sheet 2 800 depicted in FIGS. 7 and 8. The end 338 of the Human Resource Input Process is reached.

The Value Factor Selection Process 400 is depicted in FIG. 4. At the start 410 of the process, Management and Human Resources must identify 412 if the incentive plan is based on product, project and/or service. They must also identify 414 the product, project and/or service key attributes to be factored into the incentive plan. Ranges for key attributes 416 must be identified and as shown in step 420, it is recommended that three ranges for each key attribute be determined. All key attributes should have the same number of ranges. A numerical value (e.g., from 1 to 3) is assigned to each key attribute range column.

The next step 418 comprises establishing the product, project and/or Service Value Factor Matrix. A sample Value Factor Matrix 422 is provided in Tool Calculation Flowchart Sheet 1 700 depicted in FIG. 7. In step 426, a product, project and/or Service Value Factor Table is created. The Value Factor Table is based on possible outcomes derived from the Value Factor Matrix. As shown in step 424, a sample Value Factor Table is provided in Tool Calculation Flowchart Sheet 1 700 depicted in FIG. 7.

The incentive plan start and end dates 214/428 are input 438 from the Management Input Flowchart 200. A determination 430 of eligible products, projects and/or services for bonus incentive plan inclusion is made and a list is created at step 432. In step 434, the List of eligible products, projects and/or services is output 436 to the Success Factor Flowchart 500 depicted in FIG. 5. In step 440, Management and Human Resources determine the Value Factor for all eligible products, projects and/or services. The products, projects and/or services Value Factor is based upon the Value Factor Table. As shown in step 442, an example table is provided in Tool Calculation Flowchart Sheet 1 700 depicted in FIG. 7.

The final step 444 in the Value Factor Flowchart 400 comprises creating a Value Factor List 446 for all eligible products, projects and/or services. The Value Factor List 446 is output 448 to the Success Factor Flowchart 500. Step 450 concludes the development of the weighted Value Factor process.

FIG. 5 details the Success Factor Flowchart 500. At the start 510 of the process, it must be determined if the Client has an established control process 512. If no, then the process comprises step 514; establishing a Client control process based on industry standards and indoctrinating the Client's employees on the control process. After step 514, or if step 514 is bypassed because it was determined that the Client already had established a control process, the Success Factor determination proceeds to step 516 and employs the Client's formal product, project and/or service control process.

The next step 518 in the Success Factor determination is to establish product, project and/or service success factors, preferably based on the Client's documented metrics. Management or Human Resources should create at step 520 a Success Factor Matrix. As shown in step 522, an example Success Factor Matrix is provided in Tool Calculation Flowchart Sheet 2 800 depicted in FIG. 8.

A determination 524 shall be made, when—in the product, project and/or service life cycle—its success factors should be evaluated. Typically, as shown in step 526, a product has completed its life cycle when it is delivered to a client, a project when it completes its warranty period, and a service after provided to a client.

The incentive plan start and end dates 214/528 is input 530 at from the Management Input Process. The List of eligible products, projects and/or services 434/532 is input 534 from the Value Factor Flowchart 400.

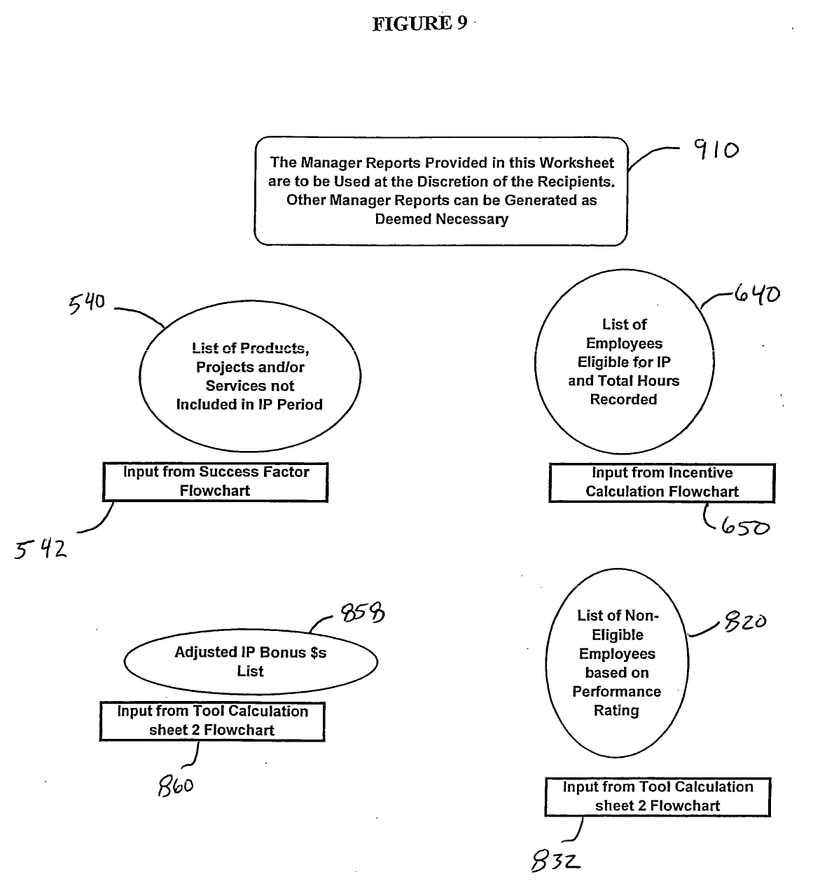

A decision point 536 is reached. Will the product, project and/or service complete the life cycle prior to plan end date? If not, as shown in step 538, the process comprises creating a list of product, project and/or service that will not be included in incentive plan for the period and stating the reason for it not being included. A list of products, projects and/or services not included in the incentive plan period 540 is output 542 to Manager Reports Worksheet depicted in FIG. 9.

Alternatively, if the product, project and/or service will complete the life cycle prior to plan end date, a subsequent decision point 544 is reached: Has the product, project and/or service completed its life cycle? If it has not, the process will hold until it does by looping back to decision point 544. If the product, project and/or service has completed its life cycle, the product, project and/or service Success Score is determined at step 550 utilizing the Value Factor List 446/546 input 548 from the Value Factor Flowchart 400. Next. The product, project and/or service Success Score equals the success factor results evaluated against the Success Factor Matrix multiplied by its value factor as set forth in step 552. An example calculation is provided in Tool Calculation Flowchart Sheet 2 800 depicted in FIG. 8.

At step 558 of the Success Factor Process, a list of products, projects and/or services success scores is finalized. The Final List of products, projects and/or services Success Scores 554 is output 556 to the Incentive Calculation Flowchart 600 depicted in FIG. 6. Determination of the Success Scores is concluded as step 560.

The start of incentive calculations process 610 requires the input of a list of total hours employees recorded to products, projects and services 612. Preferably, the list should be generated at least three weeks prior to the incentive plan end date. The Final List of products, projects and/or services Success Scores 554/614 is input 616 from the Success Factor Flowchart 500.

Decision point 618 is reached wherein Management and Human Resources must determine if the hours an employee recorded were recorded against, or on, the list of final products, projects and/or services. If the hours recorded were not recorded against or on the list of final products, projects and/or services, as show in step 620, the ineligible hours are removed from the employee's Final Total Hours Recorded List. If the hours are on the list, a subsequent decision point 626 is reached: Did the employee record the minimum hours to an eligible product, project and/or service (i.e., the product, project and/or service is on Final List). The minimum hours per product, project and/or service required for inclusion in the bonus calculation 230/622 is input 624 from Manager Input Flowchart 200. If the minimum hours recorded were not recorded against or to an eligible product, project, and/or service, as show in step 628, the ineligible hours are removed from the employee's Final Total Hours Recorded List.

The Final Employee Total Hours Recorded List is calculated at step 630 using the minimum number of total hours recorded for the incentive plan period 236/632 input 634 from Manager Input Flowchart 200. A subsequent decision point 636 is reached: Did the employee record the minimum total number of hours? If not, as shown in step 638, the employee is not included as eligible on the incentive plan list. If the employee did record the minimum total number of hours, a List of Employees Eligible for the Incentive Plan is created at step 640 including Total Hours Recorded. Next, at step 642, the Employee Weighted Average Success Score is determined.

As set out in step 644, in order to determine the Employee Weighted Average Success Score, first calculate a given product, project and/or service Success Score and the percentage of total hours an employee worked on all eligible products, projects and/or services. Next, multiply the percentage of total hours by the given product, project and/or services Success Score. Finally, add the sum of all the weighted Success Scores to obtain an Employee's Weighted Average Success Score.

Finally, a list of eligible Employees' Weighted Average Success Scores and the Total Eligible Hours Recorded is created at step 646. The Employee Weighted Average Success Score list and Total Eligible Hours Recorded 648 is output 650 to the Tool Calculation Flowchart Sheet 1 700 depicted in FIG. 7 and to the Manager Reports depicted in FIG. 9. The incentive calculation is concluded at step 652.

FIG. 7 provides the details of the Tool Calculation Flowchart Sheet 1. At the start of the calculation 710, the Employees Weighted Average Success Score List and Total Eligible Hours Recorded 648/712 are input 714 from the Incentive Calculation Flowchart 600. The Human Resources Data for All Employees per Funding Pool 334/716 is input 718 taken from the Human Resource Input Flowchart 300.

Human Resources or Management create, at step 720, a Tool Worksheet comprising a number of preferable fields having already been completed, including the calculated fields. Input Fields 722 preferably include: Manager Name, ID Number, Employee Name, Salary, Bonus Salary, Bonus Target, Dept. ID and Employee Review/Scorecard Rating (source—Human Resources); Weighted Average Success Score (source—Incentive Calculations); Funding Pool (source—Management Input); and Employees Eligible for incentive plan (source—Incentive Calculations). Calculated Fields include: Target Bonus Dollars, Adjusted Target Bonus Dollars, Review Flag, Employee Potential Bonus Percentage, Potential Incentive Plan Bonus Dollars, Adjusted Incentive Plan Bonus Dollars and Bonus as a Percentage of Target Bonus Dollars.

Human Resources and/or Management calculates the Employee's Target Bonus Dollars 724. The Employee's Target Bonus Dollars equals the employee's bonus salary times the employee's bonus target as depicted in step 726. At step 728, Human Resources and/or Management calculates the Total Employees' Target Bonus Dollars. As shown in step 730, the Total Employees' Target Bonus Dollars equals the Sum of Bonus Dollars for all employees.

The Incentive Plan Funding per Pool 264/732 is input 734 from the Manager Input Flowchart 200 and the Number of Manager Funding Pools 256/736 is input 738 from the Manager Input Flowchart 200. Subsequently, at step 740, Human Resources and/or Management calculates the percentage of Bonus Dollars for Each Funding Pool. As depicted in step 742, a percentage of Bonus Dollars equals the Incentive Plan Funding Pool Divided by the Total Employees' Target Bonus Dollars (in the given funding pool). In step 744, the Adjusted Employee's Target Bonus Dollars is calculated. As shown in step 746, the Adjusted Employee's Target Bonus Dollars equals the percentage of Bonus Dollars multiplied by Employee's Target Bonus Dollars for each employee in that Funding Pool (calculated for each funding pool). The Employee Percentage of Bonus Based on Incentive Plan 322/748 is input 754 from the Human Resource Input Flowchart 300.

At 750, the process comprises calculating the Total Incentive Funding Dollars Available per Funding Pool. As shown in step 752, the Total Incentive Funding Dollars Available per Funding Pool equals the Sum of the Adjusted Employee's Target Bonus Dollars for those employees eligible for the incentive plan for the given Funding Pool multiplied by the percentage of Bonus based on the incentive plan. The Total Incentive Funding Dollars Available per Funding Pool 756 is output 758 to the Tool Calculation Flowchart Sheet 2 800 depicted in FIG. 8. The Tool Calculation Flowchart Sheet 1 process concludes at step 760.

In FIG. 800, the Tool Calculation Flowchart Sheet 2 is depicted. At the start 810, Human Resources Data for All Employees per Funding Pool 334/812 is input 814 from the Human Resource Input Flowchart 300. In step 816, Human Resources and/or Management must determine if an employee is eligible for the incentive plan based on the employee's performance rating. If the employee is eligible, the Maximum Bonus Potential Table 224/824 is input 826 from the Manager Input Flowchart 200. If the employee is not eligible as shown in step 818, the employee is listed as not eligible for the incentive plan based on the Employee's Performance Rating. The List of Non-Eligible Employees based on Performance Rating 820 is output 832 to the Manager Reports.

Human Resources and/or Management calculates the Maximum Employee Incentive Plan Bonus Dollars at step 830. As shown in step 834, the Maximum Employee Incentive Plan Bonus Dollars equals the Maximum Bonus Potential Percentage (source—Maximum Bonus Potential Table) multiplied by the Employee's Target Bonus Dollars. At step 836, the Total Maximum Employee Incentive Plan Bonus Dollars per Funding Pool is calculated. As shown in step 838, the Total Maximum Employee Incentive Plan Bonus Dollars per Funding Pool equals the Sum of Maximum Employee Incentive Plan Bonus Dollars per Funding Pool.

The Total Incentive Funding Dollars Available per Funding Pool 756/844 is input 846 from Tool Calculation Sheet #1 700. Subsequently in step 840, the Employee Incentive Plan Bonus Percentage per Funding Pool is calculated. As shown in step 842, the Employee Incentive Plan Bonus Percentage equals the Total Incentive Funding Dollars Available divided by the Total Maximum Employee Incentive Plan Bonus Dollars per Funding Pool. Decision Point 848 is reached: Is the Employee Incentive Plan Bonus Percentage per Funding Pool greater than 100%? If it is, it is limited at step 850 to 100%.

In step 852, each eligible Employee's Adjusted Incentive Plan Bonus Dollars per Funding Pool is calculated. As shown in step 854, the Employee's Adjusted Incentive Plan Bonus Dollars equals the Maximum Employee Incentive Plan Bonus Dollars multiplied by the Incentive Plan Bonus percentage per Funding Pool. In step 856, the Adjusted Incentive Plan Bonus Dollars for Each Employee per Funding Pool is documented. The Adjusted Incentive Plan Bonus Dollars List 858 is generated and is output 860 to the Manager Reports Worksheet in FIG. 9. The conclusion 862 of the Tool Calculation Sheet #2 is subsequently reached.

The Manager Reports are depicted in FIG. 9. The Manager Reports provided in this worksheet are to be used at the discretion of the recipients of the reports, and other Manager Reports can be generated as deemed necessary as shown in step 910. As discussed with reference to the Success Factor Flowchart 500, the list 540 of products, projects and/or services not included in the incentive plan period is received as output 542 from the Success Factor Flowchart 500.

A List 640 of Employees Eligible for the Incentive Plan including Total Hours Recorded is received as output 650 from the Incentive Calculation Flowchart 600. The Adjusted Incentive Plan Bonus Dollars List 858 is received as output 860 from the Tool Calculation Flowchart Sheet 2 800. A List of Non-Eligible Employees Based on Performance Rating 820 is also received as output 832 from Tool Calculation Flowchart Sheet 2 800.

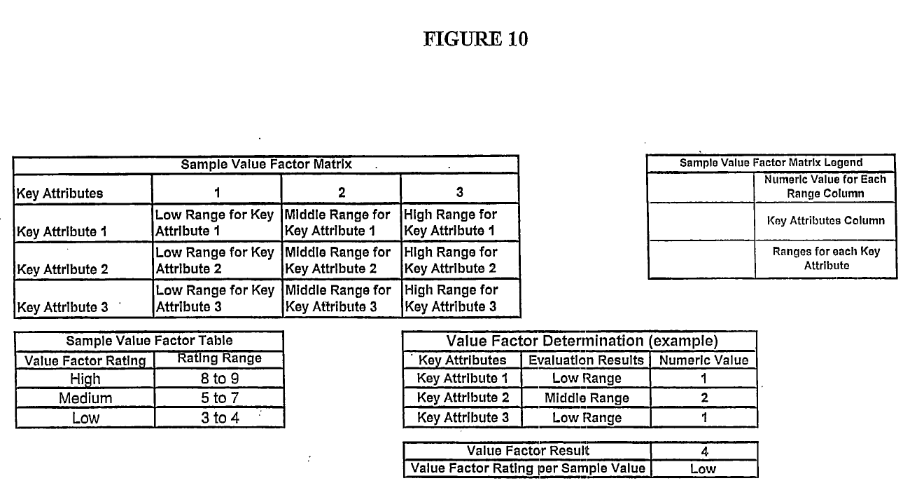

FIG. 10 provides a sample calculation and subsequent generation of a sample Value Factor Matrix, a sample Value Factor Table, and example Value Factor Determination. The purpose of the “Value Factor” is to determine the relative value of a given product, project or service compared to the other products, projects or services included in the incentive program. A “Value Factor Matrix” is employed to determine the relative value of a given product, project or service. The Value Factor Matrix consists of two components: the evaluation criteria provided in the left hand column of the matrix (key attributes 1 through 3), and the gradient range of the key attribute (Low, Middle and High range for the respective key attribute).

For example, if legal cases were the bases for an incentive program, the key attributes could be: (i) the total number of Case Hours Anticipated (key attribute 1); (ii) Case Business Value to the Law Firm (key attribute 2); and (iii) Complexity of the Case (key attribute 3). The gradient range for Case Hours Anticipated could be set at: (i) 1 through 100 (assigned a number value of 1); (ii) 101 to 500 (assigned a number value of 2); and (iii) over 500 (assigned a number value of 3). The case hours ranges would be inserted in the same row as the corresponding key attribute (Case Hours Anticipated; key attribute 1). Similarly, ranges would be determined for Business Value to the Law Firm (key attribute 2) and Complexity of the Case (key attribute 3).

Once a case has been evaluated against the gradient range, a case Value Factor is determined. For example, if a case has a lower number of Case Hours (value 1), a high Case Business Value to the Law Firm (value 3) and a medium Complexity of the Case (value 2) the resulting Value Factor is 6. The possible Value Factors form a matrix exhibiting a low of 3 to a high of 9. Therefore the Value Factor for the example has a medium overall Value Factor, reference as set forth in the “Sample Value Factor Table” shown in FIG. 10.

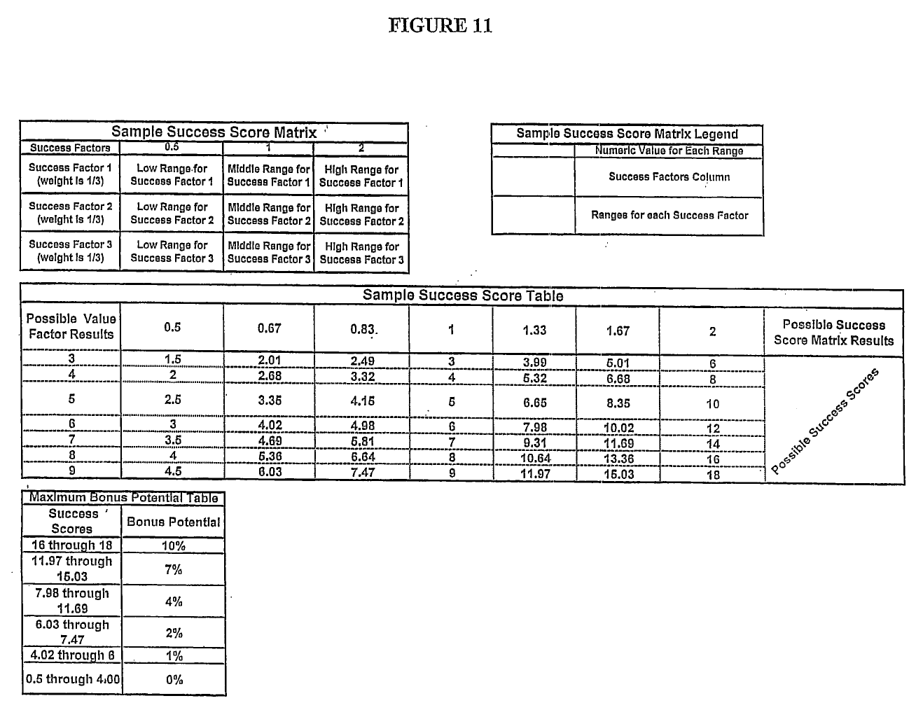

The purpose of the Success Score depicted in FIG. 11 is to determine the overall success of a given product, project or service upon completion. Success Score criteria is established prior to the start of a given product, project or service. Similar to the Value Factor, a Success Score Matrix is employed to determine the Success Score for a given product, project or service. Success Factors are listed in the left hand column of the Matrix and the Success Factor's associated gradients are listed in the columns to the right of the respective Success Factor.

For example, if legal cases were the bases for an incentive program, the Success Factors could be: (i) the Contingency Recovery Rate or Fixed Fee Recovery Rate (Success Factor 1); (ii) Client Feedback (Success Factor 2); and (iii) Case Tree (Success Factor 3). The gradient range for the Contingency Recovery Rate or Fixed Fee Rate could be: (i) the dollars recovered were less than a Targeted Rate (assigned a number value of 0.5); (ii) the dollars recovered equaled a Target Rate (assigned a number value of 1); and the dollars recovered exceeded a Target Rate (assigned a number value of 2). Similarly, gradient ranges would be determined for Client Feedback and Case Tree Success Factors.

Once a case has been completed, the Success Score is determined. For example, if a case results in the dollars recovered being less than the Target Rate for the Contingency Recovery Rate (value 0.5), a high Client Feedback (value 2) and a medium Case Tree (value 1), the resulting Success Score is 3.5 divided by 3, or 1.67.

The Value Factor multiplied by the Success Score determines the Maximum Bonus Potential for all the individuals working on a particular case. Therefore the Maximum Bonus Potential for this example comprises a Value Factor of 6 (from the Value Factor example) multiplied times a Success Score of 1.67; equaling a Maximum Bonus Potential for this example of 10.2. From the Maximum Bonus Potential Table also depicted in FIG. 11, each employee working on this example case would be potentially eligible for a bonus of 4% of their annual salary.

As used throughout the specification and the Figures, the term “product, project and/or service” refers to any one of a variety of typical employer output. In order to properly claim the present invention, the term “employer output” will be used.

Although the invention has been described in considerable detail with respect to the particular embodiments of Applicant's preferred method and system for designing and implementing an employee incentive plan, it will be apparent that the invention is capable of numerous modifications and variations, apparent to those skilled in the art, without departing from the spirit and scope of the invention.

1. A method for developing and implementing an employee incentive plan comprising:
a) establishing an employer management team;
b) establishing an employer human resources management team;
c) establishing at least one performance unit upon which an employee eligibility in the incentive plan will be based;
d) selecting at least one employer output to be included in the incentive plan;
e) defining at least one key attribute for each employer output against which employee performance can be measured;
f) calculating a value factor for each employer output included in the incentive plan;
g) defining at least one success factor for each employer output against which employee performance can be measured;
h) calculating a success score for each employer output included in the incentive plan;
i) determining an employee's eligibility in the incentive plan by measuring the performance units attributed to the employee tracked against the selected employer output; and
j) calculating a bonus recommendation.

2. The method for developing and implementing an employee incentive plan of claim 1 wherein the at least one performance unit is selected from the group of number of hours worked, number of units produced, and number of units sold.

3. The method for developing and implementing an employee incentive plan of claim 1 further comprising:
a) establishing an incentive plan start and end date;
b) determining a maximum bonus percentage potential for employees based on the success score for each employer output included in the incentive plan;
c) determining a minimum number of performance units that an employee must achieve against the selected employer output to be included in the incentive plan;
d) determining a minimum number of total performance units that an employee must achieve against the selected employer output to be included in the incentive plan;
e) determining an incentive plan funding formula;
f) determining the number of funding pools, employees in each funding pool, and funding level for each funding pool; and
g) determining an employee percentage of the bonus recommendation based upon individual performance units measured against the employer output.

4. The method for developing and implementing an employee incentive plan of claim 3 further comprising:
a) defining a plurality of key attributes for each employer output against which employee performance can be measured
b) defining a plurality of key attribute ranges for each key attribute;
c) calculating the key attributes of the selected employer output;
d) calculating the value factor by summing the calculated key attributes;
e) establishing a plurality of success factors for the selected employer output;
f) defining a plurality of success score ranges for each success factor;
g) calculating the success factor of the selected employer output;
h) calculating the success score of the selected employer output by averaging the success scores of the success factors; and
i) calculating a maximum bonus potential for employees that worked on the selected employer output by multiplying the value factor by the success score.

5. The method for developing and implementing an employee incentive plan of claim 4 further comprising:
a) establishing an employee target percentage bonus;
b) obtaining the employee's salary data;
c) calculating the employee's target bonus dollars by multiplying the employee's salary by the employee's target percentage bonus;
d) calculating a total employee target bonus dollar amount by summing all employee's target bonus dollars;
e) calculating a percentage of an employer's available bonus dollars required for each funding pool by dividing each funding pool by the total employee target bonus dollar amount for the employees in the funding pool;
f) calculating an adjusted employee target bonus dollars by multiplying the percentage of the employer's available bonus dollars by the employee target bonus dollars for each employee in the funding pool;
g) calculating a total incentive funding dollar amount available for each funding pool by summing the adjusted employee target bonus dollars for employees eligible to participate in the incentive plan based upon measured performance units multiplied by the employee target percentage bonus;
h) calculating a maximum employee bonus dollar amount by multiplying the maximum bonus potential by the employee target bonus dollars;
i) calculating the total maximum employee bonus dollars for each funding pool by summing the maximum employee bonus dollar amount of each employee in the funding pool;
j) calculating the incentive plan bonus percentage for each funding pool by dividing the total incentive funding dollar amount available by the total maximum employee bonus dollars for each funding pool;
k) ensuring the incentive plan bonus percentage for each funding pool does not exceed 100% by setting it to 100% if it exceeds 100%;
l) calculating an adjusted bonus dollar amount for each employee in a funding pool by multiplying the maximum employee bonus dollar amount by the incentive plan bonus percentage for the funding pool; and
m) recommending the adjusted bonus dollar amount for each employee in a funding pool to employer management team.
